(19) United States
(12) Patent Application Publication
(10) Pub. No.: US 2010/0029806 A1
(43) Pub. Date: Feb. 4, 2010

(54) ENCAPSULATED COLORANT, INK COMPOSITION INCLUDING THE COLORANT AND METHOD OF PREPARING THE SAME

(75) Inventors: Jae-yoon JUNG, Suwon-si (KR); Seung-min Ryu, Gunpo-si (KR); Jong-in Lee, Suwon-si (KR); Sang-eun Shim, Incheon Metropolitan-City (KR)

Correspondence Address: DLA PIPER LLP US, P. O. BOX 2758, RESTON, VA, 20195, US

(73) Assignee: SAMSUNG ELECTRONICS CO., LTD., Suwon-si (KR)

(21) Appl. No.: 12/469,763

(22) Filed: May 21, 2009

(30) Foreign Application Priority Data
Jul. 30, 2008 (KR) 10-2008-0074706

(51) Int. Cl. C09D 11/10; C09D 151/00

(52) U.S. Cl. 523/205; 523/201

(57) ABSTRACT

Provided is an encapsulated colorant including a colorant grafted with a water-soluble polymer and a polymer resin coating the colorant. Also provided is a method of preparing the same.

### CROSS-REFERENCE TO RELATED PATENT APPLICATION

This application claims the benefit of Korean Patent Application No. 10-2008-0074706, filed on Jul. 30, 2008, in the Korean Intellectual Property Office, the disclosure of which is incorporated by reference in its entirety.

### TECHNICAL FIELD

This disclosure relates to inks, particularly, an encapsulated colorants having a colorant grafted to a water-soluble polymer and a polymer resin coating the colorant and a method of preparing the encapsulated colorants.

### BACKGROUND

Colorants embody their inherent colors by selectively absorbing or reflecting visible light. Colorants are often classified as either dyestuffs or pigments.

Dyestuffs are used in materials to be dyed, such as fibers, leathers, furs and papers. They provide fastness to washing, friction, etc. Pigments are usually in the form of fine particles. They are directly adhered to the surface of the material to be dyed, by physical means (e.g., adhesion, etc.), thereby providing their inherent colors. Dyestuffs are dissolved in solvents such as water. Pigments are generally insoluble in such solvents. Thus, it is important to homogeneously disperse pigment fine particles in a solution and stably maintain the dispersed state without re-aggregation. A water-soluble dyestuff-type ink may be superior in long-term storage stability and its long-term homogeneity. Also, its color and brightness are clear. However, water-soluble dyestuff-type ink may have poor waterfastness, light resistance, etc.

Pigment-type ink has high optical density (OD), excellent waterfastness and light resistance and little bleeding between colors. It may have poor color clearness and poor long-term storage stability compared to dyestuff-type ink. In addition, images printed using pigment-type inks often have poor dry and wet rub fastness, i.e., abrasion resistance.

When printing in colors (multicolor printing) with dyestuffs or pigments, bleeding at interfaces of each color may occur and, thus, clearness of images is weakened. There is a need for ink composition having superior storage stability, which is a characteristic of the water-soluble dyestuff-type ink, good waterfastness, which is a characteristic of the pigment-type ink, printed gloss and abrasion resistance.

A technique of adding resin to an ink composition has been suggested to improve abrasion resistance of ink. However, the resin may increase viscosity of the ink. Although a technique of adding resin particles to ink to inhibit viscosity of ink from being increased has been suggested, abrasion resistance is not sufficiently improved since the resin particles and the pigments are independently dispersed in the ink.

There are methods of encapsulating a colorant with a resin. Even though the encapsulated colorant may improve image quality, abrasion resistance and waterfastness, unreacted monomers often remain in the encapsulated colorant solution. These influence physical properties of the ink such as viscosity and surface tension. Furthermore, optical density of images printed on paper may decrease since the permeation of ink is increased, and uniformity of printed images may decrease.

### SUMMARY

The disclosure provides encapsulated colorants including: a colorant crafted with a water-soluble polymer; and a polymer resin coating the colorant. This disclosure also provides methods of preparing encapsulated colorants. One method includes: preparing a colorant grafted with a water-soluble polymer by sonicating an aqueous dispersion including a colorant, at least one water-soluble polymer, and an aqueous medium; preparing a colorant-monomer-containing emulsion by emulsifying a polymerization composition including the colorant grafted with the water-soluble polymer, at least one unsaturated monomer, an aqueous medium, and an emulsifier; and encapsulating the colorant using a polymer resin formed by polymerizing the colorant-monomer-containing emulsion. The disclosure also provides an ink composition including an encapsulated colorant. The disclosure also provides an ink set including at least two types of the ink compositions. The disclosure also provides a cartridge for an inkjet recording apparatus including the ink set. The disclosure also provides an inkjet recording apparatus including the cartridge.

Without being bound by theory, the conversion rate of an encapsulation process may be increased by removing free radicals of the surface of a colorant. The free radicals are removed by grafting the colorant with a polymer formed by degrading a water-soluble polymer using sonication before the process of encapsulating the surface of the colorant using a polymer resin. The encapsulated colorant prepared as described above has waterfastness, light resistance, abrasion resistance, optical density properties, and image uniformity. These properties prevent nozzles from being blocked and maintain storage stability. The encapsulated colorant may be efficiently used in an ink composition, an ink set, a cartridge for an inkjet recording apparatus, an inkjet recording apparatus, or the like.

### BRIEF DESCRIPTION OF THE DRAWINGS

The above and other features and advantages will become more apparent by describing in detail forms thereof with reference to the attached drawings in which:

FIG. 1 is a perspective view of an inkjet recording apparatus including an ink cartridge; and

FIG. 2 is a cross-sectional view of an inkjet printer cartridge.

### DETAILED DESCRIPTION

The disclosure will now be described more fully with reference to the accompanying drawings, in which various forms are shown.

An encapsulated colorant includes: a colorant; and a polymer resin coating the colorant. In order to increase a conversion rate of a polymerization process for forming the polymer resin coating the colorant, free radicals of the surface of the colorant are removed by grafting the colorant with a water-soluble polymer degraded by sonication before the encapsulation process. The sonication procedure produces free radicals in the water-soluble polymer. Since radicals of an initiator used in the polymerization process after grafting the colorant with the water-soluble polymer react with the free radicals of the surface of the colorant, the free radicals of the colorant are removed. This may prevent the conversion rate from being reduced. As the conversion rate is increased, the amount of unreacted monomers remaining in the colorant solution may be reduced. Thus, interaction between an organic solvent used in the preparation of ink and an emulsifier may be inhibited. Therefore, physical properties of ink may be stably maintained for a long period of time, image quality may be improved, and reliability of ink may be improved.

The colorant used to constitute the core of the encapsulated colorant may be dyestuffs and pigments and virtually any known colorant. That is, direct dyes, acid dyes, edible dyes, alkali dyes, reactive dyes, dispersing dyes, oil dyes, various pigments, self-dispersing pigments, or mixtures thereof can be used as the colorant. Examples of the dyes are food black dyes, food red dyes, food yellow dyes, food blue dyes, acid black dyes, acid red dyes, acid blue dyes, acid yellow dyes, direct black dyes, direct blue dyes, direct yellow dyes, anthraquinone dyes, monoazo dyes, disazo dyes, and phthalocyanine derivatives, and examples of the pigments are carbon black, graphite, vitreous carbon, activated charcoal, activated carbon, anthraquinone, phthalocyanine blue, phthalocyanine green, diazos, monoazos, pyranthrones, perylene, quinacridone, and indigoid pigments. Examples of the self-dispersing pigments are cabojet-series and CW-series of Orient Chemical.

Any water-soluble polymer may be grafted on the surface of the colorant, and the water-soluble polymer may be used alone or in combination of at least two types thereof. The water-soluble polymer may include at least one selected from the group consisting of polyoxyalkylene-based polymer such as polyethylene glycol, polypropylene glycol, and a propylene glycol copolymer; polyacryl-based polymer such as sodium polyacrylate, polyethylacrylate and polyacrylamide; cellulose-based polymer such as methylcellulose, hydrophobized hydroxypropylmethylcellulose, hydroxyethylcellulose, and hydroxypropylcellulose; and polyvinyl-based polymer such as poly(vinyl alcohol), poly(vinyl acetate), and poly(vinyl pyrrolidone).

In this regard, the amount of the water-soluble polymer grafted on the colorant may be in the range of about 5 to about 150 parts by weight, preferably about 10 to about 100 parts by weight, and more preferably about 14 to about 90 parts by weight based on 100 parts by weight of the colorant. If the amount of the water-soluble polymer is less than about 5 parts by weight based on 100 parts by weight of the colorant, a conversion rate of the polymerization-of the polymer resin that encapsulates the colorant may be reduced since free radicals of the colorant are not completely removed. On the other hand, if the amount of the water-soluble polymer is greater than about 150 parts by weight based on 100 parts by weight of the colorant, viscosity of the composition containing the colorant is increased due to unreacted water-soluble polymer.

A weight average molecular weight of the water-soluble polymer may be in the range of about 1,000 to about 100,000, preferably about 2,000 to about 80,000, and more preferably about 5,000 to about 50,000. If the weight average molecular weight of the water-soluble polymer is less than about 1,000, the main chain may not be degraded. On the other hand, if the weight average molecular weight of the water-soluble polymer is greater than about 100,000, solubility of the water-soluble polymer is reduced in a solution and, thus, nozzles of an inkjet recording apparatus head may be blocked during the preparation of ink.

The polymer resin encapsulating the colorant may be prepared by polymerizing a composition including at least one unsaturated monomer. Any monomer that is used in emulsion polymerization and mini-emulsion polymerization may be used as the unsaturated monomer. A polymer of a single monomer or a copolymer having a low glass transition temperature prepared by polymerizing at least two monomers may be used. For example, the polymer resin may be polystyrene-alkylacrylate, polystyrene-1,3-diene, polystyrene-alkylmethacrylate, polyacrylic acid, polystyrene-alkylmethacrylate-acrylic acid, polyalkylmethacrylate-acrylic acid, polystyrene-alkylacrylate-acrylonitrile-acrylic acid, polystyrene-1,3-diene-acrylonitrile-acrylic acid, polyalkylacrylate-acrylonitrile-acrylic acid, polystyrene-butadiene, polymethylstyrene-butadiene, polymethyl methacrylate-butadiene, polyethylmethacrylate-butadiene, polypropylmethacrylate-butadiene, polybutylmethacrylate-butadiene, polymethylacrylate-butadiene, polyethylacrylate-butadiene, polypropylacrylate-butadiene, polybutylacrylate-butadiene, polystyrene-isoprene, polymethyl-styrene-isoprene, polymethylmethacrylate-isoprene, polyethylmethacrylate-isoprene, polypropylmethacrylate-isoprene, polybutylmethacrylate-isoprene, polymethylacrylate-isoprene, polyethylacrylate-isoprene, polypropylacrylate-isoprene, polybutylacrylate-isoprene, polystyrene-propylacrylate, polystyrene-butylacrylate, polystyrene-butadiene-acrylic acid, polystyrene-butadiene-methacrylic acid, polystyrene-butadiene-acrylonitrile-acrylic acid, polystyrene-butylacrylate-acrylic acid, polystyrene-butylacrylate-methacrylic acid, polystyrenebutylacrylate-acrylonitrile, polystyrene-butylacrylate acrylonitrile-acrylic acid, or derivatives thereof.

In addition, the encapsulated colorant may be prepared using a method including: grafting a colorant with a water-soluble polymer by sonicating an aqueous dispersion including the colorant, the at least one water-soluble polymer, and an aqueous medium; preparing a colorant-monomer-containing emulsion by mixing a polymerization composition including at least one unsaturated monomer and an emulsifier with the aqueous dispersion, and homogenizing the mixture; and encapsulating the colorant using a polymer resin formed by polymerizing the colorant-monomer-containing emulsion.

Ultrasonic waves are used for grafting the water-soluble polymer on the surface of the colorant. The ultrasonic waves generate high vibration in an aqueous medium so as to cleave covalent bonds between two carbon atoms in a main chain of the water-soluble polymer and degrade the water-soluble polymer to form radicals. The degradation of the water-soluble polymer is influenced by the energy of the ultrasonic waves, which is increased as frequency, output, and processing time is increased. Thus, the frequency, output, and processing time need to be regulated in the process of grafting the colorant with the water-soluble polymer.

In this regard, the frequency of the ultrasonic waves may be in the range of about 50 to about 1,000 KHz, preferably about 100 to about 500 KHz, and more preferably about 150 to about 300 KHz. If the frequency of the ultrasonic waves is less than about 50 KHz, the water-soluble polymer may not be cleaved and, thus grafting efficiency may be reduced. If the frequency of the ultrasonic waves is greater than about 1,000 KHz, too much of the water-soluble polymer may be cleaved and, thus, it is difficult to regulate the molecular weight of the main chain and viscosity of ink. Pigment solution may be too high due to polymers, which are not attached to the surface of the pigment.

In addition, the output of the ultrasonic waves may be in the range of about 10 to about 1,000 W, preferably about 50 to about 500 W, and more preferably about 100 to about 300 W. If the output of the ultrasonic waves is less than about 10 W, degradation of the water-soluble polymer may not easily occur. If the output of the ultrasonic waves is greater than about 1,000 W, too much water-soluble polymer is cleaved such that the molecular weight of the cleaved main chain may not be regulated and the viscosity of ink and a pigment solution is too high due to polymers, which are not attached to the surface of the pigment.

The sonication may be performed for about 0.5 to about 5 hours, preferably about 1 to about 4 hours, and more preferably about 1.5 to about 3 hours. If the sonication is performed for less than about 0.5 hours, effects of sonication are negligible. If the sonication is performed for more than about 5 hours, the amount of cleaved water-soluble polymer is so large that the molecular weight of the cleaved main chain may not be regulated and the viscosity of ink and a pigment solution is too high. This is due to polymers which are not attached to the surface of the pigment.

Water or a mixed solution of water and an organic solvent may be used as the aqueous medium. The amount of the aqueous medium may be in the range of about 500 to about 5,000 parts by weight, preferably about 750 to about 4,000 parts by weight, and more preferably about 1000 to about 3,000 parts by weight based on 100 parts by weight of the colorant. If the amount of the aqueous medium is less than about 500 parts by weight based on 100 parts by weight of the colorant, the water-soluble polymer radicals may easily contact each other, and thus grafting may not be efficiently performed. On the other hand, if the amount of the aqueous medium is greater than about 5,000 parts by weight based on 100 parts by weight of the colorant, the water-soluble polymer radicals formed by sonication may not easily move to reaction sites of the surface of the colorant.

As described above, direct dyes, acid dyes, edible dyes, alkali dyes, reactive dyes, dispersing dyes, oil dyes, various pigments, self-dispersing pigments, or mixtures thereof can be used as the colorant. In this regard, the polymerizable unsaturated monomer may include at least one selected from the group consisting of a compound having at least two double bonds, unsaturated carboxylic acid, vinyl cyanide monomer, unsaturated carboxylic acid alkyl ester, unsaturated carboxylic acid hydroxyalkyl ester, unsaturated carboxylic acid amide and derivatives thereof, aromatic vinyl monomer, vinyl lactam and derivatives thereof, methyl vinyl ketone, and vinylidene chloride. The compound having at least two double bonds may be at least one selected from the group consisting of butadiene and pentadiene; the unsaturated carboxylic acid may be at least one selected from the group consisting of methacrylic acid, acrylic acid, itaconic acid, crotonic acid, fumaric acid and maleic acid; the unsaturated polycarboxylic acid alkyl ester may be at least one selected from the group consisting of itaconic acid monoethyl ester, fumaric acid monobutyl ester and maleic acid monobutyl ester; the vinyl cyanide monomer may be acrylonitrile or methacrylonitrile; the unsaturated carboxylic acid amide may be acryl amide, methyacryl amide, itaconic amide or maleic acid mono amide or derivatives thereof; and the aromatic vinyl monomer may be at least one selected from the group consisting of styrene, α-methylstyrene, vinyl toluene, P-methylstyrene, or derivatives thereof.

The amount of the unsaturated monomer may be in the range of about 5 to about 150 parts by weight, preferably about 7 to about 120 parts by weight, and more preferably about 10 to about 100 parts by weight based on 100 parts by weight of the colorant grafted with the water-soluble polymer. If the amount of the unsaturated monomer is less than about 5 parts by weight based on 100 parts by weight of the colorant grafted with the water-soluble polymer, the amount of the resin coated on the colorant is too low and, thus, fixing properties or the like may not be sufficiently realized. On the other hand, if the amount of the unsaturated monomer is greater than about 150 parts by weight based on 100 parts by weight of the colorant grafted with the water-soluble polymer, a polymer of unsaturated monomer that does not participate in the encapsulation reaction may be formed and, thus, storage stability of ink compositions may be decreased.

The emulsifier may be a nonionic, an anionic or an ampholytic emulsifier. The amount of the emulsifier may be in the range of about 0.5 to about 30 parts by weight, preferably about 0.7 to about 20 parts by weight, and more preferably about 0.7 to about 10 parts by weight based on 100 parts by weight of the colorant grafted with the water-soluble polymer. If the amount of the emulsifier is less than about 0.5 parts by weight based on 100 parts by weight of the colorant grafted with the water-soluble polymer, it is less than a critical micelle concentration and, thus, emulsion polymerization may not be efficient. On the other hand, if the amount of the emulsifier is greater than about 30 parts by weight based on 100 parts by weight of the colorant grafted with the water-soluble polymer, bubbles may be generated due to excess amount of the emulsifier after the reaction.

Water or a mixed solution of water and an organic solvent may be used as the aqueous medium. The amount of the aqueous medium may be in the range of about 500 to about 5,000 parts by weight, preferably about 750 to about 4,000 parts by weight, and more preferably about 1,000 to about 3,000 parts by weight based on 100 parts by weight of the colorant grafted with the water-soluble polymer. If the amount of the aqueous medium is less than about 500 parts by weight based on 100 parts by weight of the colorant grafted with the water-soluble polymer, the polymerization is performed so quickly that the polymer resin encapsulating the colorant becomes too thick. If the amount of the aqueous medium is greater than about 5,000 parts by weight based on 100 parts by weight of the colorant grafted with the water-soluble polymer, the polymerization is performed so slowly due to uneasy movement of the unsaturated monomer to reaction sites that encapsulation of the polymer resin may not be easily performed.

The emulsification may be direct emulsification in which the unsaturated monomer and the colorant are emulsified in an aqueous medium including an emulsifier using a homogenizer such as a homo mixer, a line mixer, or a high pressure homogenizer, or natural emulsification in which an emulsifier is added to a dispersion of the unsaturated monomer and the colorant and the mixture is poured into a large amount of the aqueous medium. Alternatively, phase transition emulsification in which an emulsifier is added to a dispersion of the unsaturated monomer and the colorant and a small amount of water is added thereto while stirring the mixture may be used.

The polymerization of the colorant-monomer-containing emulsion may be performed using a polymerization initiator or by heating without a polymerization initiator. The polymerization initiator may be a water soluble or oil soluble persulfate, a peroxide, an azo compound or a peroxide and reducing agent, for example, a redox composition of a phosphorous acid salt. Examples of the polymerization initiator are ammonium persulfate, potassium persulfate, sodium persulfate, hydrogen peroxide, t-butyl hydroxy peroxide, t-butyl peroxy benzoate, 2,2-azobis-isobutyronitrile, 2,2-azobis(2-diaminopropane)hydrochloride and 2,2-azobis(2,4-dimethylvaleronitrile).

The amount of the polymerization initiator may be in the range of about 0.5 to about 30 parts by weight, and preferably about 0.7 to about 10 parts by weight based on 100 parts by weight of the unsaturated monomer. If the amount of the polymerization initiator is less than about 0.5 parts by weight based on 100 parts by weight of the unsaturated monomer, it is difficult to initiate the polymerization and, thus, the polymerization is performed too slowly. On the other hand, if the amount of the polymerization initiator is greater than about 30 parts by weight based on 100 parts by weight of the unsaturated monomer, it is difficult to control the reaction speed since the polymerization is performed too quickly.

The polymerization initiator may be added to the polymerization reaction with other ingredients such as the unsaturated monomer, the aqueous medium, and the colorant in the initial stage of the reaction, or added thereto after preparing an emulsion by combining the other ingredients, homogenizing and heating the mixture. In addition, if desired, the polymerization composition including the unsaturated monomer and the emulsifier may include additives such as a UV absorber, an antioxidant, a color developer, and a chain transfer agent.

A crosslinking degree of the polymer resin constituting the encapsulated colorant may be controlled by regulating the amount of the chain transfer agent and by varying the methods of adding the chain transfer agent.

In the ink composition, the amount of the encapsulated colorant may be in the range of about 1 to about 20 parts by weight, preferably about 2 to about 10 parts by weight, and more preferably about 3 to about 7 parts by weight based on 100 parts by weight of the ink composition. If the amount of the encapsulated colorant is less than about 1 part by weight based on 100 parts by weight of the ink composition, desired optical density may not be obtained. On the other hand, if the amount of the encapsulated colorant is greater than about 20 parts by weight based on 100 parts by weight of the ink composition, viscosity of the ink composition is increased too high and ejecting efficiency may be decreased.

The solvent used in the ink composition may be a water-based solvent such as water, and may further include at least one organic solvent. The amount of the solvent may be in the range of about 80 to about 99 parts by weight, preferably about 83 to about 95 parts by weight, and more preferably about 85 to about 93 parts by weight based on 100 parts by weight of the ink composition.

If the amount of the solvent is less than about 80 parts by weight based on 100 parts by weight of the ink composition, viscosity of the ink composition is too high and ejecting efficiency may be decreased. On the other hand, if the amount of the solvent is greater than about 99 parts by weight based on 100 parts by weight of the ink composition, surface tension of the ink composition is increased affecting ejecting efficiency.

The organic solvent in the water-based solvent may include at least one of an alcohol, a ketone, an ester, a nitrogen-containing compound, and a sulfur-containing compound. The alcohol may be a monohydric alcohol such as methyl alcohol, ethyl alcohol, n-propyl alcohol, isopropyl alcohol. n-butyl alcohol, sec-butyl alcohol, t-butyl alcohol or isobutyl alcohol, or a polyhydric alcohol such as ethylene glycol, diethylene glycol, triethylene glycol, propylene glycol, butylene glycol, 1,4-butanediol, 1,2,4-butanetriol, 1,5-pentanediol, 1,2,6-hexanetriol, hexylene glycol, glycerol, glycerol ethoxylate or trimethylol propane ethoxylate.

The monohydric alcohol controls surface tension of ink and, thus, can improve permeation and dot formation properties in a recording medium such as paper for professional or nonprofessional use and drying properties of the printed image. The polyhydric alcohol and its derivatives are not easily evaporated, and lower the freezing point of the ink; Thus, these can improve storage stability of the ink and prevent nozzles from being blocked. The ketone may be acetone, methylethyl ketone, diethyl ketone or diacetone alcohol. The ester may be methyl acetate, ethyl acetate or ethyl lactate. Examples of the nitrogen-containing compound are 2-pyrrolidone and N-methyl-2-pyrrolidone, and examples of the sulfur-containing compound arc dimethyl sulfoxide, tetramethyl sulfone and thioglycol.

When the organic solvent is used together with a water-based solvent such as water, the amount of the organic solvent may be in the range of about 0.1 to about 130 parts by weight, and preferably about 10 to about 50 parts by weight based on 100 parts by weight of water. When the amount of the organic solvent is less than about 0.1 parts by weight based on 100 parts by weight of water, surface tension of ink may be excessive. On the other hand, when the amount of the solvent is greater than about 130 parts by weight based on 100 parts by weight of water, viscosity of the ink composition is too high, affecting ejecting efficiency.

The ink composition may further include various additives to improve properties of the ink composition. These may include at least one selected from the group consisting of a wetting agent, a dispersing agent, a surfactant, a viscosity modifier, a pH regulator, and an antioxidizing agent. The amount of the additives may be in the range of about 0.5 to about 600 parts by weight, and preferably about 10 to about 300 parts by weight based on 100 parts by weight of the colorant. When the amount of the additives is less than about 0.5 parts by weight based on 100 parts by weight of the colorant, the properties of the additives may not be effective. On the other hand, when the amount of the additives is greater than about 600 parts by weight based on 100 parts by weight of the colorant, storage stability may be decreased.

A surfactant may be, for example, an ampholytic, an anionic, a cationic or a nonionic surfactant, and any known surfactant. Examples of the ampholytic surfactant are alanine, dodecyldi(aminoethyl)glycine, di(octylaminoethyl)glycine, N-alkyl-N,N-dimethyl ammonium betaine. Examples of the anionic surfactant are alkylbenzene sulfonate, α-olefin sulfonate, polyoxyethylenealkyl ether acetate and phosphate ester. Examples of the cationic surfactant are: an amine salt surfactant such as alkyl amine salt, aminoalcohol fatty acid derivatives, polyamine fatty acid derivatives and imidazoline; and a quaternary ammonium salt surfactant such as alkyltrimethyl ammonium salt, dialkyldimethyl ammonium salt. alkyldimethyl benzylammonium salt, pyridinium salt, alkylisoquinolinium salt and benzethonium chloride salt. Examples of the nonionic surfactant are polyoxyethylenealkylether surfactant, polyoxyethylenealkylphenylether surfactant and acetylene glycol surfactant.

Preferably the nonionic surfactant is used because it has antifoaming properties. The nonionic surfactant may be SURFYNOL® of Air Products, Inc. having an acetylenic ethoxylated diol structure, TERGITOL® of Union Carbide corporation having a polyethylene oxide or polypropylene oxide structure, TWEEN® having a polyoxyethylene sorbitan fatty acid ester structure, or the like.

The ink composition may have a surface tension of about 15 to about 70 dyne/cm, preferably about 25 to about 55 dyne/cm at 20° C. and a viscosity of about 1 to about 20 cps, preferably about 1.5 to about 3.5 cps at 20° C. to have the selected properties. When the surface tension is not within the range above, printing efficiency may be decreased. When the viscosity is not within the range above, the ink may not eject properly.

Also provided is an ink set including at least two types of ink compositions. The ink set can be used in an ink receiving unit of an inkjet recording apparatus or a cartridge for an inkjet printer. An inkjet recording apparatus may include a thermal head from which ink droplets are ejected by vapour pressure obtained from heating the ink composition, a piezo head from which ink droplets are ejected by a piezo device, a disposable head or a permanent head. In addition, the inkjet recording apparatus can be a scanning type printer or an array type printer, and can be used for a desktop, textile or industrial purpose. These head types, printer types and uses of the inkjet recording apparatus are described for illustrative purposes only, and the use of the inkjet recording apparatus is not limited thereto.

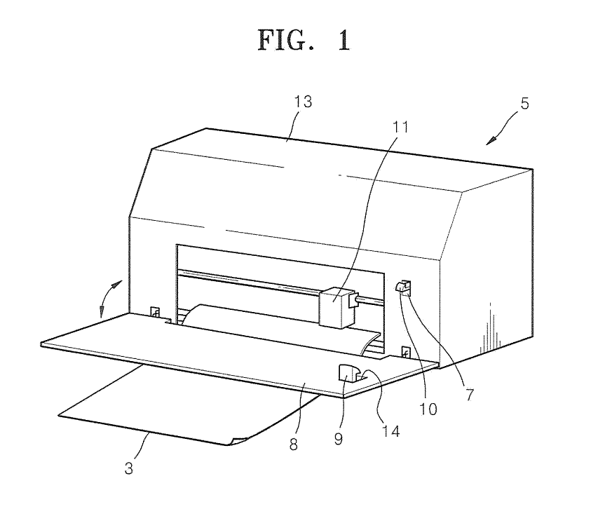

FIG. 1 is a perspective view of an inkjet recording apparatus including an ink cartridge. The inkjet recording apparatus includes an inkjet printer cartridge having an ink composition that contains a macrochromophore colorant and pseudo-colorant additives. A printer cover 8 is connected to a main body 13 of a printer 5. An engaging portion of a movable latch 10 protrudes through a hole 7. The movable latch 10 engages with a fixed latch 9 that is coupled to an inner side of the printer cover 8 when the printer cover 8 is closed. The printer cover 8 has a recess 14 in a region corresponding to the engaging portion of the movable latch 10 protruding through the hole 7. The inkjet printer cartridge 11 is positioned such that ink can be ejected onto paper 3 that passes under the ink cartridge 11.

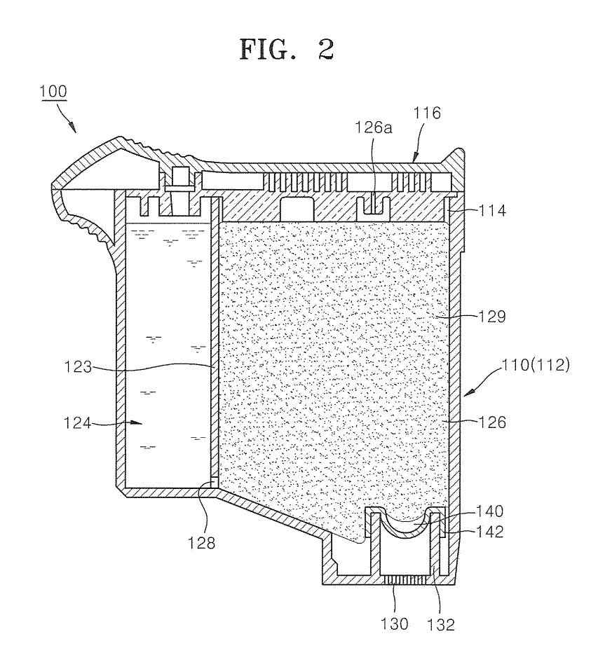

FIG. 2 is a cross-sectional view of an inkjet printer cartridge 100 including an ink set. Referring to FIG. 2, the inkjet printer cartridge 100 according to the present embodiment includes an ink cartridge main body 110 including an ink storage tank 112, an inner cover 114 covering a top portion of the ink storage tank 112, and an outer cover 116 that is spaced apart by a predetermined gap from the inner cover 114 and seals the ink storage tank 112 and the inner cover 114.

The ink storage tank 112 is divided into a first chamber 124 and a second chamber 126 by a vertical barrier wall 123. An ink passage 128 between the first chamber 124 and the second chamber 126 is formed in a bottom portion of the vertical barrier wall 123. The first chamber 124 and the sponge 129 are filled with ink, and then the second chamber 126 is filled with ink. A bent hole 126a corresponding to the second chamber 126 is formed in the inner cover 114.

In addition, a filter 140 is disposed in a lower portion of the second chamber 126, so that ink impurities and fine bubbles are filtered to prevent ejection holes of a printer head 130 from being blocked. A hook 142 is formed in the edge of the filter 140 and is coupled to a top portion of a standpipe 132. Thus, ink is ejected from the ink storage tank 120 onto a printing medium in a liquid-drop form through the ejection holes of the printer head 130.

The following examples are for illustrative purposes only and are not intended to limit the scope of this disclosure or the appended claims.

### PREPARATION OF ENCAPSULATED COLORANT—PREPARATION EXAMPLES 1-1 TO 1-5: PREPARATION OF COLORANT GRAFTED WITH WATER-SOLUBLE POLYMER

A carbon black diluent was prepared by diluting Cabojet 300 (containing 15% by weight of carbon black), in which carbon black is dispersed in water, to 10% by weight. Then, poly(vinyl alcohol) PVA 1 and PVA 2 purchased by Sigma Aldrich Corporation having the amount and the weight average molecular weight shown in Table 1 were added to the carbon black diluent, and the mixtures were stirred at 40 to 50° C. for about one day to prepare a dispersion of carbon black and poly(vinyl alcohol). The dispersion was sonicated at 200 kHz and at 200 W for 2 hours to degrade poly (vinyl alcohol) to form radicals so that the radicals could form covalent bonds with free radicals of the surface of the carbon black using grafting. The surface of the carbon black was observed using a transmission electron microscope (TEM).

TABLE 1

| | Carbon | PVA 1 | PVA 2 | |
|---|---|---|---|---|
| | black | (weight average | (weight average | |
| | 10% | molecular weight: | molecular weight: | |
| | diluent | 9,000~10,000) | 31,000~50,000) | Water |
| | (g) | (g) | (g) | (g) |
| Preparation | 67 | 1 | — | 33 |
| Example 1-1 | | | | |
| Preparation | 67 | 2 | — | 33 |
| Example 1-2 | | | | |
| Preparation | 67 | 4 | — | 33 |
| Example 1-3 | | | | |
| Preparation | 67 | — | 1 | 33 |
| Example 1-4 | | | | |
| Preparation | 67 | — | 2 | 33 |
| Example 1-5 | | | | |

### EXAMPLES 1-1 TO 1-5

### Preparation of Encapsulated Colorant

A critical micelle concentration (CMC) of sodium dodecyl sulfate (SDS), as an emulsifier, was added to the dispersion in which carbon black grafted with poly(vinyl alcohol) prepared according to Preparation Examples 1-1 to 1-5 was dispersed. Then, styrene and butylacrylate were added thereto as monomers in a weight ratio of 6:4. The reactor was purged for longer than 30 minutes in a nitrogen atmosphere and heated to a polymerization temperature (80° C.). Then, potassium persulfate (KPS), as an initiator, was added thereto and the mixture was polymerized in a nitrogen atmosphere for 24 hours. The amounts of the carbon black grafted with poly (vinyl alcohol), SDS, water, the monomers (styrene and butylacrylate), and KPS are shown in Table 2 below.

TABLE 2

| | | | | | Monomer (g) | |
|---|---|---|---|---|---|---|
| | | | | | (styrene:butyl | |
| | Carbon black grafted with | | | | acrylate = | |
| | poly(vinyl alcohol) | | SDS | Water | 6:4) (weight | KPS |
| | Example | Amount (g) | (g) | (g) | ratio) | (g) |
| Preparation | Example 1-1 | 10 | 0.3 | 155 | 7.5 | 0.075 |
| Example 1-1 | | | | | | |
| Preparation | Example 1-2 | 10 | | | | |
| Example 1-2 | | | | | | |
| Preparation | Example 1-3 | 10 | | | | |
| Example 1-3 | | | | | | |
| Preparation | Example 1-4 | 10 | | | | |
| Example 1-4 | | | | | | |
| Preparation | Example 1-5 | 10 | | | | |
| Example 1-5 | | | | | | |

### COMPARATIVE EXAMPLE 1

Encapsulated colorant was prepared in the same manner as in Example 1-1, except that CaboJet 300, which is generally used in the art, was used instead of the colorant prepared according to Preparation Example 1-1.

Preparation of Ink Composition

Encapsulated colorant prepared according to Examples 1-1 to 1-5, water, organic solvents, and additives were mixed in the composition described below, and the mixture was sufficiently stirred for 30 minutes to form a uniform state. The mixture was passed through a 0.8 μm filter to prepare an ink composition of Examples 2-1 to 2-5.

### EXAMPLE 2-1 TO 2-5

| | |
|---|---|
| Encapsulated colorant prepared in | 4.5 parts by weight |
| Examples 1-1 to 1-5 | |
| Glycerol | 7.5 parts by weight |
| Diethylene glycol | 8 parts by weight |
| Nonionic surfactant (Surfynol 465, | 0.6 parts by weight |
| Air Products, Inc. | |
| Water (deionized water) | 79 parts by weight |

### COMPARATIVE EXAMPLE 2

| | |
|---|---|
| Encapsulated | 4.5 parts by weight |
| prepared in Comparative Example 1 | |
| Glycerol | 7.5 parts by weight |
| Diethylene glycol | 8 parts by weight |
| Nonionic surfactant (Surfynol 465, | 0.6 parts by weight |
| Air Products, Inc.) | |
| Water (deionized water) | 79 parts by weight |

Measurement of Conversion Rate

A reaction solution prepared according to Examples 1-1 to 1-5 and Comparative Example 1 was diluted 1,000 times with deionized water, and a conversion rate of the diluent was measured using toluene as an internal reference material using gas chromatography (GC, Agilent). The results are shown in Table 3 below.

TABLE 3

| | Conversion rate (%) |
|---|---|
| Example 1-1 | 99.5 |
| Example 1-2 | 99.6 |
| Example 1-3 | 99.9 |
| Example 1-4 | 99.6 |
| Example 1-5 | 99.8 |
| Comparative | 82.1 |
| Example 1 | |

Referring to Table 3, the conversion rate of polymerization according to Examples 1-1 to 1-5 using the colorant grafted with the water-soluble polymer such as poly(vinyl alcohol) was greater than that of polymerization according to Comparative Example 1 using the colorant merely encapsulated with the polymer resin.

Cartridge Storage Stability Test

The degree of nozzle blocking was measured when printing was performed after storing each of the ink compositions prepared according to Examples 2-1 to 2-5 and Comparative Example 2 in an M-50 ink cartridge (Samsung Corporation) at room temperature (25° C.) and a low temperature (−5° C.) for 2 weeks, and the results are shown in Table 4 below 4.

⊚: 10% or less nozzles were blocked

◯: 10-20% nozzles were blocked

□: 20-30% nozzles were blocked

X: 30% or more nozzles were blocked

Ink storage stability test-viscosity

Each of the ink compositions prepared according to Examples 2-1 to 2-5 and Comparative Example 2 was stored in an M-50 ink cartridge (Samsung Corporation) at a high temperature (60° C.) and a very low temperature (−18° C.) for 4 weeks. Then, viscosity was compared with initial viscosity, and the difference in viscosity was measured. The results are shown in Table 4 below.

⊚: 7% or less change in average rate of viscosity

◯: 7-14% change in average rate of viscosity

□: 14-20% change in average rate of viscosity

X: 20% or more change in average rate of viscosity

Ink Storage Stability Test-Surface Tension

Each of the ink compositions prepared according to Examples 2-1 to 2-5 and Comparative Example 2 was stored in an M-50 ink cartridge (Samsung Corporation) at a high temperature (60° C.), and a very low temperature (−18° C.) for 4 weeks. Then, surface tension was compared with initial surface tension, and the difference in surface tension was measured. The results are shown in Table 4 below.

⊚: 5% or less change in average rate of surface tension

◯: 5-10% change in average rate of surface tension

□: 10-20% change in average rate of surface tension

X: 20% or more change in average rate of surface tension

Optical Density (OD) Test

Each of the ink compositions prepared according to Examples 2-1 to 2-5 and Comparative Example 2 was refilled into an M-50 ink cartridge (Samsung Corporation), and a bar pattern (2×10 cm) was printed using a printer (MJC-3300p, Samsung Corporation). The printed resultant was dried for 24 hours. Then. OD of the image was evaluated as shown below, and the results are shown in Table 4 below.

A=OD of image

⊚: A≧1.4

◯: 1.3≦A<1.4

□: 1.2≦A<1.3

X: A<1.2

Uniformity Test

Each of the ink compositions prepared according to Examples 2-1 to 2-5 and Comparative Example 2 was refilled into an M-50 ink cartridge (Samsung Corporation), and a bar pattern (2×10 cm) was printed using a printer (MJC-3300p, Samsung Corporation). The printed resultant was dried for 24 hours. Then, standard deviation of OD of the image was evaluated using a tester, and the results are shown in Table 4 below.

A=Standard deviation of OD of the image

⊚: A<0.02

◯: 0.02≦A<0.05

□: 0.05≦A<0.1

X: A≧0.1

Abrasion Resistance Test p Each of the ink compositions prepared according to Examples 2-1 to 2-5 and Comparative Example 2 was refilled into an M-50 ink cartridge (Samsung Corporation), and a bar pattern (2×10 cm) was printed using a printer (MJC-3300p, Samsung Corporation). The printed resultant was dried for 24 hours. Then, abrasion resistance of the image was evaluated using a tester, and the results are shown in Table 4 below.

A=Standard deviation of OD of the image

⊚: A<5%

◯: 5%≦A<10%

□: 10%≦A<20%

X: A≧20%

Waterfastness Test

Each of the ink compositions prepared according to Examples 2-1 to 2-5 and Comparative Example 2 was refilled into an M-50 ink cartridge (Samsung Corporation), and a bar pattern (2×10 cm) was printed using a printer (MJC-3300p, Samsung Corporation). The printed resultant was dried for 24 hours. Then, waterfastness of the image was evaluated using a tester, and the results are shown in Table 4 below.

A=Waterfastness of image

⊚: A<5%

◯: 5%≦A<10%

□: 10%≦A<15%

X: A≧15%

TABLE 4

| | | | Storage | | | | |
|---|---|---|---|---|---|---|---|
| | Cartridge | Storage | stability | | | | |
| | storage | stability | (surface | | Abrasion | | Optical |
| | stability | (viscosity) | tension) | Uniformity | resistance | Waterfastness | density |
| Example 2-1 | ⊚ | ⊚ | ⊚ | ⊚ | ⊚ | ⊚ | ⊚ |
| Example 2-2 | ◯ | ◯ | ⊚ | ⊚ | ⊚ | ⊚ | ⊚ |
| Example 2-3 | ◯ | ⊚ | ◯ | ◯ | ⊚ | ⊚ | ⊚ |
| Example 2-4 | □ | □ | ◯ | ◯ | ⊚ | ⊚ | ⊚ |
| Example 2-5 | □ | □ | □ | ◯ | □ | □ | □ |
| Comparative | X | X | □ | □ | □ | ◯ | □ |
| Example 2 | | | | | | | |

Referring to Table 4, the ink compositions according to Examples 2-1 to 2-5 include encapsulated colorant grafted with the water-soluble polymer. Thus, images obtained using the ink compositions can have excellent waterfastness, light resistance, abrasion resistance, optical density properties, and uniformity, nozzles can be prevented from being blocked, and excellent reliability such as storage stability of ink can be realized.

While the disclosure has been particularly shown and described with reference to exemplary forms thereof, it will be understood by those of ordinary skill in the art that various changes in form and details may be made therein without departing from the spirit and scope thereof as defined by the following claims.

What is claimed is:

1. An encapsulated colorant comprising:
a colorant grafted with a water-soluble polymer; and
a polymer resin coating the colorant.

2. The encapsulated colorant of claim 1, wherein the water-soluble polymer comprises at least one selected from the group consisting of a polyoxyalkylene-based polymer, a polyacryl-based polymer, a cellulose-based polymer, and a polyvinyl-based polymer.

3. The encapsulated colorant of claim 1, wherein the water-soluble polymer comprises at least one selected from the group consisting of polyethylene glycol, polypropylene glycol, a polyethylene glycol-propylene glycol copolymer, sodium polyacrylate, polyethylacrylate, polyacrylamide, methylcellulose, hydrophobized hydroxypropylmethylcellulose, hydroxyethylcellulose, hydroxypropylcellulose, poly(vinyl alcohol), poly(vinyl acetate), and poly(vinyl pyrrolidone).

4. The encapsulated colorant of claim 1, wherein the amount of the water-soluble polymer is about 5 to about 150 parts by weight based on 100 parts by weight of the colorant.

5. The encapsulated colorant of claim 1, wherein a weight average molecular weight of the water-soluble polymer is about 1,000 to about 100,000.

6. A method of preparing an encapsulated colorant, the method comprising:
preparing a colorant grafted with a water-soluble polymer by sonicating an aqueous dispersion comprising the colorant, at least one water-soluble polymer, and an aqueous medium;
preparing a colorant-monomer-containing emulsion by emulsifying a polymerization composition comprising the colorant grafted with the water-soluble polymer, at least one unsaturated monomer, an aqueous medium, and an emulsifier; and
encapsulating the colorant using a polymer resin formed by polymerizing the colorant-monomer-containing emulsion.

7. The method of claim 6, wherein in the preparing of the colorant grafted with the water-soluble polymer, the amount of the water-soluble polymer is about 5 to about 150 parts by weight, and the amount of the aqueous medium is about 500 to about 5,000 parts by weight based on 100 parts by weight of the colorant.

8. The method of claim 6, wherein, in the preparing of the colorant-monomer-containing emulsion, the amount of the unsaturated monomer is about 5 to about 150 parts by weight, the amount of the aqueous medium is about 500 to about 5,000 parts by weight, and the amount of the emulsifier is about 0.5 to about 30 parts by weight based on 100 parts by weight of the colorant grafted with the water-soluble polymer.

9. The method of claim 6, wherein the unsaturated monomer comprises at least one selected from the group consisting of a compound having at least two double bonds, unsaturated carboxylic acid, vinyl cyanide monomer, unsaturated carboxylic acid alkyl ester, unsaturated carboxylic acid hydroxyalkyl ester, unsaturated carboxylic acid amide, aromatic vinyl monomer, vinyl lactam, methyl vinyl ketone, vinylidene chloride, unsaturated amine, unsaturated pyridine, unsaturated azole, and derivatives thereof.

10. The method of claim 6, wherein the sonication is performed at a frequency of about 50 to about 1,000 KHz and at about 10 to about 1,000 W for about 0.5 to about 5 hours.

11. An ink composition comprising:
a colorant grafted with a water soluble polymer and a polymer resin coating the colorant; and
a solvent.

12. The ink composition of claim 11, wherein the amount of the encapsulated colorant is about 1 to about 20 parts by weight and the amount of the solvent is about 80 to about 99 parts by weight based on 100 parts by weight of the ink composition.

13. The ink composition of claim 11, wherein the solvent comprises at least one organic solvent selected from the group consisting of an alcohol, a ketone, an ester, a nitrogen-containing compound, and a sulfur-containing compound, and water.

14. The ink composition of claim 11, wherein the ink composition has a surface tension of about 15 to about 70 dyne/cm at about 20° C. and a viscosity of about 1 to about 20 cps at about 20° C.

15. An ink set comprising at least two types of ink compositions comprising an encapsulated colorant according to claim 1.

16. A cartridge for an inkjet recording apparatus comprising the ink set of claim 15.

17. An inkjet recording apparatus comprising the cartridge of claim 16.

18. A method of preparing an encapsulated colorant, the method comprising:
providing an aqueous dispersion comprising:
a colorant; and
at least one water-soluble polymer; and
an aqueous medium;
grafting the water-soluble polymer to the colorant;
emulsifying the colorant with the grafted water-soluble polymer, at least one unsaturated monomer, an aqueous medium, and an emulsifier;
forming a polymer resin by polymerizing the product of the emulsifying step; and
encapsulating the colorant with grafted water-soluble polymer with the polymer resin.
